(19) United States
(12) Patent Application Publication
(10) Pub. No.: US 2016/0363827 A1
(43) Pub. Date: Dec. 15, 2016

(54) LIQUID CRYSTAL DISPLAYS AND THE VERTICAL ALIGNMENT LIQUID CRYSTAL PANELS THEREOF

(71) Applicant: Wuhan China Star Optoelectronics Technology Co.,, Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/761,114

(22) PCT Filed: Jun. 17, 2015
(86) PCT No.: PCT/CN2015/081633

§ 371 Date: Jul. 15, 2015

(30) Foreign Application Priority Data
Jun. 15, 2015 (CN) 2015103297940

(51) Int. Cl. G02F 1/1343

(52) U.S. Cl. CPC G02F 1/134363; G02F 2201/121; G02F 2201/123

(57) ABSTRACT

The present disclosure relates to a liquid crystal display and the vertical alignment liquid crystal panel thereof. The liquid crystal panel includes a first substrate having at least one pixel electrode and at least one common electrode, and a second substrate having at least one twisted electrode. The twisted electrode corresponds to one of the common electrode and the pixel electrodes. When being applied with the voltage, a tilt electrical field is formed between the twisted electrode and the common electrode such that the vertically aligned liquid crystals are controlled to reorientate. In this way, the dark stripes of the liquid crystal panel may be eliminated so as to enhance the transmission rate.

### BACKGROUND OF THE INVENTION

1. Field of the Invention

The present disclosure relates to liquid crystal display technology, and more particularly to a liquid crystal display (LCD) and the vertical alignment liquid crystal panel thereof.

2. Discussion of the Related Art

Vertical alignment liquid crystal molecules may not reorientate when the liquid crystal panel has not applied a voltage. Light beams passing through the liquid crystal molecules cannot pass through the liquid crystal panel such that the liquid crystal panel is in a normal black mode. When being applied with the voltage, the vertical alignment liquid crystal molecules reorientate so as to be gradually horizontal due to the horizontal electrical field, and thus the light beams may pass through the liquid crystal panel and the liquid crystal panel may display images. However, the liquid crystal molecules located between pixel electrodes and common electrodes may be clasped by the liquid crystal molecules located in two sides, and thus are vertically aligned. Under the circumstance, the light beams cannot pass through the middle area, and thus dark strips may occur in the liquid crystal panel such that the transmission rate has been affected.

### SUMMARY

The present disclosure relates to a liquid crystal display and the vertical alignment liquid crystal panel thereof. With the configuration, the dark stripes of the liquid crystal panel may be eliminated so as to enhance the transmission rate.

In one aspect, a vertical alignment liquid crystal panel includes: a first substrate, a second substrate opposite to the first substrate, and positive liquid crystals between the first substrate and the second substrate, the first substrate comprising at least one pixel electrode and at least one common electrode, the common electrode and the pixel electrode are stripe-like structures arranged along a surface of the first substrate, and the common electrode and the pixel electrode are spaced apart from each other, the second substrate comprising at least one stripe-like twisted electrodes arranged along the surface of the second substrate, and the twisted electrodes being spaced apart from each, the twisted electrode being configured to be corresponding to the common electrode, when the common electrode, the pixel electrode, and the twisted electrode being applied with a voltage, a horizontal electrical field being formed between the common electrode and the pixel electrode and a tilt electrical field being formed between the twisted electrode and the common electrode such that the vertically aligned liquid crystals are controlled to reorientate by the horizontal electrical field and the tilt electrical field.

Wherein the voltage being applied to the twisted electrode and the common electrode are the same.

Wherein the voltage being applied to the twisted electrode and the common electrode are different.

In another aspect, a vertical alignment liquid crystal panel includes: a first substrate, a second substrate opposite to the first substrate, and positive liquid crystals between the first substrate and the second substrate, the first substrate comprising at least one pixel electrode and at least one common electrode, the second substrate comprising at least one twisted electrodes arranged along the surface of the second substrate, the twisted electrode being configured to be corresponding to one of the common electrode and the pixel electrode, and when the common electrode, the pixel electrode, and the twisted electrode being applied with a voltage, a tilt electrical field being formed between the twisted electrode and the corresponding common electrode or the corresponding pixel electrodes such that the vertically aligned liquid crystals are controlled to reorientate.

Wherein the twisted electrode is configured to be corresponding to the common electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

Wherein the voltage being applied to the twisted electrode and the common electrode are the same.

Wherein the voltage being applied to the twisted electrode and the common electrode are different.

Wherein the twisted electrode is configured to be corresponding to the pixel electrode, when the common electrode, the pixel electrode, and the twisted electrode being applied with the voltage, a horizontal electrical field is formed between the common electrode and the pixel electrode and a tilt electrical field is formed between the twisted electrode and the pixel electrode such that the vertically aligned liquid crystals are controlled to reorientate by the horizontal electrical field and the tilt electrical field.

Wherein the voltage being applied to the twisted electrode and the common electrode are the same.

Wherein the voltage being applied to the twisted electrode and the common electrode are different.

Wherein the common electrode and the pixel electrode are stripe-like structures arranged along a surface of the first substrate, and the common electrode and the pixel electrode are spaced apart from each other, and the second substrate comprises at least one stripe-like twisted electrodes arranged along the surface of the second substrate.

Wherein the liquid crystals are positive liquid crystals.

In another aspect, a liquid crystal display (LCD) includes: a first substrate, a second substrate opposite to the first substrate, and positive liquid crystals between the first substrate and the second substrate, the first substrate comprising at least one pixel electrode and at least one common electrode, the second substrate comprising at least one twisted electrodes, the twisted electrode being configured to be corresponding to one of the common electrode and the pixel electrode, and when the common electrode, the pixel electrode, and the twisted electrode being applied with a voltage, a tilt electrical field being formed between the twisted electrode and the corresponding common electrode or the corresponding pixel electrodes such that the vertically aligned liquid crystals are controlled to reorientate.

Wherein the twisted electrode is configured to be corresponding to the common electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

Wherein the twisted electrode is configured to be corresponding to the pixel electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

Wherein the voltage being applied to the twisted electrode and the common electrode are the same.

Wherein the voltage being applied to the twisted electrode and the common electrode are different.

Wherein the common electrode and the pixel electrode are stripe-like structures arranged along a surface of the first substrate, and the common electrode and the pixel electrode are spaced apart from each other, the second substrate comprising at least one stripe-like twisted electrodes arranged along the surface of the second substrate, and the twisted electrodes being spaced apart from each.

Wherein the liquid crystals are positive liquid crystals.

In view of the above, the twisted electrode has been configured to be corresponding to the common electrode and the pixel electrodes. In addition, the tilt electrical field formed between the common electrode and the pixel electrodes may control the vertically aligned liquid crystals located in the middle area between the pixel electrodes and the common electrode to reorientate. As such, the light beams may pass through the area to eliminate the dark strips, which enhances the transmission rate.

### BRIEF DESCRIPTION OF THE DRAWINGS

FIG. 1 is a cross-sectional view of the liquid crystal panel in accordance with a first embodiment when no voltage has been applied to the liquid crystal panel.

FIG. 2 is a schematic view of the liquid crystal panel of FIG. 1 when being applied with the voltage.

FIG. 3 is a cross-sectional view of the liquid crystal panel in accordance with a second embodiment when no voltage has been applied to the liquid crystal panel.

FIG. 4 is a schematic view of the liquid crystal panel of FIG. 3 when being applied with the voltage.

### DETAILED DESCRIPTION OF THE EMBODIMENTS

Embodiments of the invention will now be described more fully hereinafter with reference to the accompanying drawings, in which embodiments of the invention are shown.

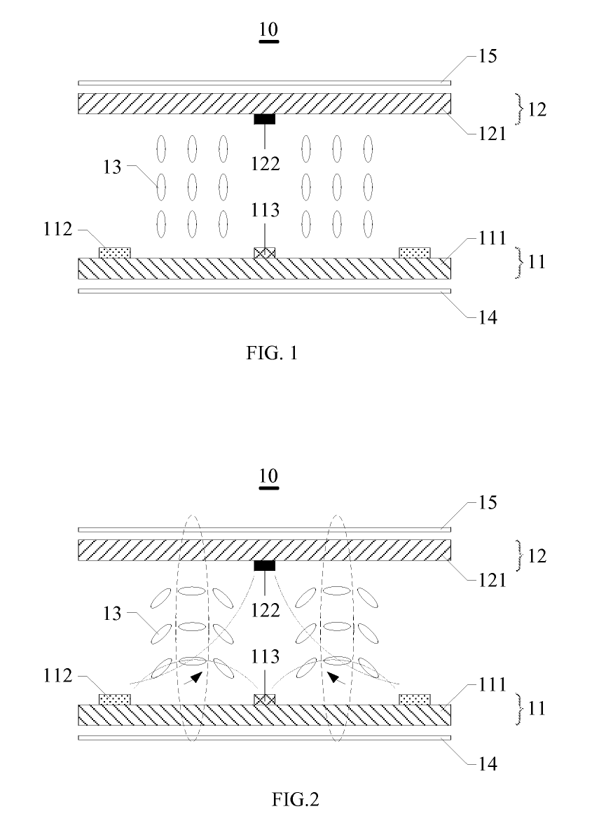

FIG. 1 is a cross-sectional view of the liquid crystal panel in accordance with a first embodiment when no voltage has been applied to the liquid crystal panel. As shown, the liquid crystal panel 10 includes a first substrate 11, a second substrate 12, and a liquid crystal layer 13 between the first substrate 11 and the second substrate 12. The first substrate 11 and the second substrate 12 are opposite to each other, and are arranged at a certain distance. The first substrate 11 is an array substrate, such as a thin film transistor (TFT) substrate. The first substrate 11 includes a transparent body 111, at least one pixel electrode 112, at least one common electrode 113 and a variety of wiring arranged on the transparent body 111. As the pixel electrode 112 and the common electrode 113 are arranged on the same substrate, the liquid crystal panel 10 may be driven by the horizontal electrical field, which may also be deemed as IPS liquid crystal panel. The second substrate 12 is a color film (CF) substrate. The second substrate 12 includes a transparent body 121 and a twisted electrode 122 on the transparent body 121.

In the embodiment, the transparent body 111 and the transparent body 121 may be glass substrates, quartz substrates, plastic substrates, or other kinds of hard or flexible substrate. The material of the transparent body 111 and the pixel electrode 112 may be the same or may be different. In addition, the twisted electrode 122 is arranged to be corresponding to the common electrode 113. For instance, the pixel electrode 112 and the common electrode 113 may be stripe-like structure arranged along the surface of the first substrate 11, and the pixel electrode 112 and the common electrode 113 are spaced apart from each other. Correspondingly, the twisted electrode 122 may be stripe-like structure arranged along the surface of the second substrate 12, and the twisted electrode 122 and the common electrode 113 are spaced apart from each other.

In the embodiment, the liquid crystal panel 10 is the vertical alignment liquid crystal panel. That is, when no voltage has been applied to the liquid crystal panel 10, the liquid crystal molecules are vertically aligned, as shown in FIG. 1. In addition, the liquid crystal panel 10 further includes a first polarizer 14 arranged at a farther surface of the first substrate 11 with respect to the liquid crystal layer 13. The liquid crystal panel 10 further includes a second polarizer 15 arranged at a farther surface of the second substrate 12 with respect to the liquid crystal layer 13. The polarized direction of the first polarizer 14 and the second polarizer 15 are perpendicular to each other.

When no voltage has been applied to the liquid crystal panel 10, the pixel electrode 112, the common electrode 113, and the twisted electrode 122 have not been applied with the voltage. There is no electrical field being generated between any two of the pixel electrode 112, the common electrode 113, and the twisted electrode 122. Thus, the vertical alignment liquid crystal molecules may not reorientate. At this moment, the light beams pass through the first polarizer 14, the liquid crystal layer 13 and then arrive the second polarizer 15. As the polarized direction of the first polarizer 14 and the second polarizer 15 are perpendicular to each other, the light beams are not capable of passing through the second polarizer 15. That is, the second polarizer 15 blocks the light beams passing through the first polarizer 14 and the liquid crystal layer 13, which results in that the liquid crystal panel is in the normal black mode.

When the liquid crystal panel 10 has been applied with the voltage, the pixel electrode 112, the common electrode 113, and the twisted electrode 122 have been applied with the voltage. The horizontal electrical field has been formed between the common electrode 113 and the pixel electrode 112 as shown in FIG. 2. A tilt electrical field has been formed between the twisted electrode 122 and the pixel electrode 112, as shown in FIG. 2. The horizontal electrical field and tilt electrical field cooperatively control the liquid crystal molecules 13 to reorientate. The tilt electrical field may understood by referring to the dashed area of FIG. 2, i.e., a middle area between the pixel electrode 112 and the common electrode 113. The liquid crystal molecules 13 may reorientate due to the horizontal electrical field, and then reorientate along with directions of the arrows due to the tilt electrical field. The liquid crystal molecules 13 located in the middle area between the pixel electrode 112 and the common electrode 113 reorientate toward the horizontal direction due to the tilt electrical field such that the light beams may pass through the first polarizer 14 within the middle area and the liquid crystal molecules 13 within the liquid crystal layer. Afterward, the polarized direction of the light beams has changed, and thus the light beams may pass through the second polarizer 15, which eliminates the dark stripes occurred in the middle area.

In an example, the voltage applied to the twisted electrode 122 and the common electrode 113 may be the same or different. The force of the tilt electrical field may be controlled by configuring the voltage being applied to the twisted electrode 122 and the common electrode 113. In this way, the amount of light beams passing through the liquid crystal panel 10 (the second polarizer 15) may be controlled, which enhances the transmission rate of the liquid crystal panel 10.

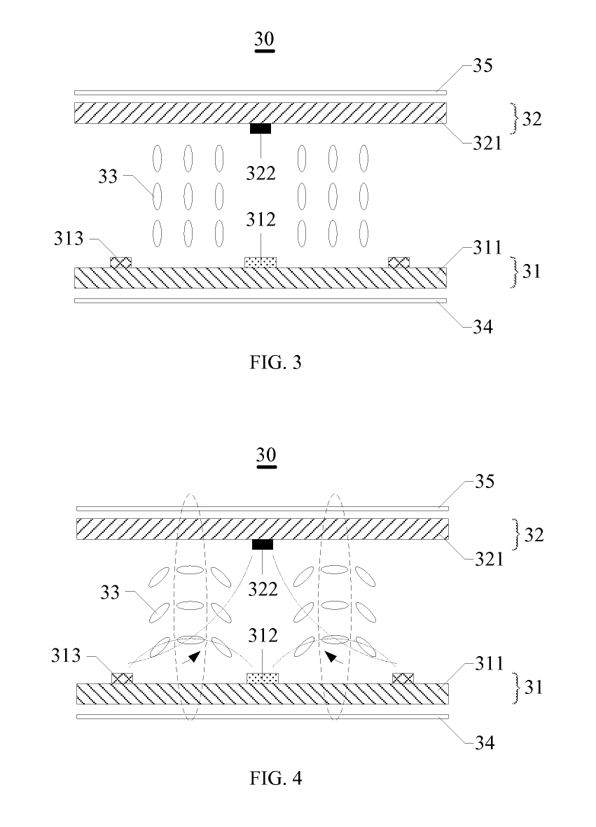

FIG. 3 is a cross-sectional view of the liquid crystal panel in accordance with a second embodiment when no voltage has been applied to the liquid crystal panel. In the embodiment, the liquid crystal panel 30 includes a first substrate 31, a second substrate 32, and a liquid crystal layer 33 between the first substrate 31 and the second substrate 32. The first substrate 11 is an array substrate. The first substrate 11 includes a transparent body 311, at least one pixel electrode 312, at least one common electrode 313 and a variety of wiring arranged on the transparent body 311. The second substrate 32 is a color film (CF) substrate. The second substrate 32 includes a transparent body 321 and a twisted electrode 322 on the transparent body 321.

The difference between the first embodiment in FIG. 1 and the second embodiment resides in that the twisted electrode 322 is a stripe-like structure being configured to be corresponding to the common electrode 313.

Before the liquid crystal panel 30 has been applied with the voltage, referring to FIG. 3, the light beams passing through the first polarizer 34 and liquid crystal molecules 33 within the liquid crystal layer are not capable of passing through the second polarizer 35. At this moment, the liquid crystal panel 30 is in the normal black mode.

When the liquid crystal panel 30 has been applied with the voltage, the horizontal electrical field has been formed between the common electrode 313 and the pixel electrode 312. The tilt electrical field has been formed between the twisted electrode 322 and the common electrode 313. The horizontal electrical field and tilt electrical field cooperatively control the liquid crystal molecules 33 to reorientate.

The tilt electrical field may understood by referring to the dashed area of FIG. 4, i.e., a middle area between the pixel electrode 312 and the common electrode 313. The liquid crystal molecules 33 may reorientate due to the horizontal electrical field, and then reorientate along with directions of the arrows. The liquid crystal molecules 33 located in the middle area between the pixel electrode 312 and the common electrode 313 reorientate toward the horizontal direction due to the tilt electrical field such that the light beams may pass through the first polarizer 34 within the middle area and the liquid crystal molecules 33 within the liquid crystal layer. Afterward, the polarized direction of the light beams has changed, and thus the light beams may pass through the second polarizer 35, which eliminates the dark stripes occurred in the middle area.

Referring to FIGS. 2 and 4, the twisted electrode has been configured in different locations in the first and the second embodiment. The generated tilt electrical field may result in opposite polarized direction for the liquid crystal molecules 33 located in the middle area between the pixel electrode 312 and the common electrode 313.

According to the present disclosure, a liquid crystal display may include the liquid crystal panel 10 in FIGS. 1 and 2 or the liquid crystal panel 30 in FIGS. 3 and 4.

In view of the above, the twisted electrode is configured to be spaced apart with the common electrode or the pixel electrode correspondingly. In addition, the vertically aligned liquid crystal molecules located in the middle area between the pixel electrode and the common electrode are controlled to reorientate toward the horizontal direction due to the tilt electrical field formed due to the twisted electrode and the common electrode or the pixel electrode. In this way, the light beams may pass through the middle area so as to avoid the dark stripes in the area, which enhances the transmission rate of the liquid crystal panel.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A vertical alignment liquid crystal panel, comprising:
a first substrate, a second substrate opposite to the first substrate, and positive liquid crystals between the first substrate and the second substrate, the first substrate comprising at least one pixel electrode and at least one common electrode, the common electrode and the pixel electrode are stripe-like structures arranged along a surface of the first substrate, and the common electrode and the pixel electrode are spaced apart from each other, the second substrate comprising at least one stripe-like twisted electrodes arranged along the surface of the second substrate, and the twisted electrodes being spaced apart from each, the twisted electrode being configured to be corresponding to the common electrode, when the common electrode, the pixel electrode, and the twisted electrode being applied with a voltage, a horizontal electrical field being formed between the common electrode and the pixel electrode and a tilt electrical field being formed between the twisted electrode and the common electrode such that the vertically aligned liquid crystals are controlled to reorientate by the horizontal electrical field and the tilt electrical field.

2. The liquid crystal panel as claimed in claim 1, wherein the voltage being applied to the twisted electrode and the common electrode are the same.

3. The liquid crystal panel as claimed in claim 1, wherein the voltage being applied to the twisted electrode and the common electrode are different.

4. A vertical alignment liquid crystal panel, comprising:
a first substrate, a second substrate opposite to the first substrate, and positive liquid crystals between the first substrate and the second substrate, the first substrate comprising at least one pixel electrode and at least one common electrode, the second substrate comprising at least one twisted electrodes arranged along the surface of the second substrate, the twisted electrode being configured to be corresponding to one of the common electrode and the pixel electrode, and when the common electrode, the pixel electrode, and the twisted electrode being applied with a voltage, a tilt electrical field being formed between the twisted electrode and the corresponding common electrode or the corresponding pixel electrodes such that the vertically aligned liquid crystals are controlled to reorientate.

5. The liquid crystal panel as claimed in claim 4, wherein the twisted electrode is configured to be corresponding to the common electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

6. The liquid crystal panel as claimed in claim 5, wherein the voltage being applied to the twisted electrode and the common electrode are the same.

7. The liquid crystal panel as claimed in claim 5, wherein the voltage being applied to the twisted electrode and the common electrode are different.

8. The liquid crystal panel as claimed in claim 4, wherein the twisted electrode is configured to be corresponding to the pixel electrode, when the common electrode, the pixel electrode, and the twisted electrode being applied with the voltage, a horizontal electrical field is formed between the common electrode and the pixel electrode and a tilt electrical field is formed between the twisted electrode and the pixel electrode such that the vertically aligned liquid crystals are controlled to reorientate by the horizontal electrical field and the tilt electrical field.

9. The liquid crystal panel as claimed in claim 8, wherein the voltage being applied to the twisted electrode and the common electrode are the same.

10. The liquid crystal panel as claimed in claim 8, wherein the voltage being applied to the twisted electrode and the common electrode are different.

11. The liquid crystal panel as claimed in claim 4, wherein the common electrode and the pixel electrode are stripe-like structures arranged along a surface of the first substrate, and the common electrode and the pixel electrode are spaced apart from each other, and the second substrate comprises at least one stripe-like twisted electrodes arranged along the surface of the second substrate.

12. The liquid crystal panel as claimed in claim 4, wherein the liquid crystals are positive liquid crystals.

13. A liquid crystal display (LCD), comprising:
a first substrate, a second substrate opposite to the first substrate, and positive liquid crystals between the first substrate and the second substrate, the first substrate comprising at least one pixel electrode and at least one common electrode, the second substrate comprising at least one twisted electrodes, the twisted electrode being configured to be corresponding to one of the common electrode and the pixel electrode, and when the common electrode, the pixel electrode, and the twisted electrode being applied with a voltage, a tilt electrical field being formed between the twisted electrode and the corresponding common electrode or the corresponding pixel electrodes such that the vertically aligned liquid crystals are controlled to reorientate.

14. The LCD as claimed in claim 13, wherein the twisted electrode is configured to be corresponding to the common electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

15. The LCD as claimed in claim 13, wherein the twisted electrode is configured to be corresponding to the pixel electrode, when the common electrode, the pixel electrode, and the twisted electrode being applied with the voltage, a horizontal electrical field is formed between the common electrode and the pixel electrode and a tilt electrical field is formed between the twisted electrode and the common electrode such that the vertically aligned liquid crystals are controlled to reorientate by the horizontal electrical field and the tilt electrical field.

16. The LCD as claimed in claim 13, wherein the voltage being applied to the twisted electrode and the common electrode are the same.

17. The LCD as claimed in claim 13, wherein the voltage being applied to the twisted electrode and the common electrode are different.

18. The LCD as claimed in claim 13, wherein the common electrode and the pixel electrode are stripe-like structures arranged along a surface of the first substrate, and the common electrode and the pixel electrode are spaced apart from each other, the second substrate comprising at least one stripe-like twisted electrodes arranged along the surface of the second substrate, and the twisted electrodes being spaced apart from each.

19. The LCD as claimed in claim 13, wherein the liquid crystals are positive liquid crystals.
